(19) United States
(12) Patent Application Publication
(10) Pub. No.: US 2017/0099664 A1
(43) Pub. Date: Apr. 6, 2017

(54) METHOD, APPARATUS AND COMPUTER PROGRAM FOR TRANSMISSION SCHEDULING

(71) Applicant: NOKIA SOLUTIONS AND NETWORKS OY, Espoo (FI)

(72) Inventors: Timo Erkki LUNTTILA, Espoo (FI); Esa Tapani TIIROLA, Kempele (FI); Klaus HUGL, Wien (AT); Claudio ROSA, Randers (DK); Kari Juhani HOOLI, Oulu (FI); Frank FREDERIKSEN, Klarup (DK)

(21) Appl. No.: 15/280,314

(22) Filed: Sep. 29, 2016

(30) Foreign Application Priority Data
Oct. 1, 2015 (EP) PCT/EP2015/072750

(51) Int. Cl. H04W 72/04

(52) U.S. Cl. CPC H04W 72/0446; H04W 72/0413; H04W 72/0406; H04W 88/02

(57) ABSTRACT

A method comprising: receiving an uplink grant at a user equipment, the uplink grant comprising information; using the information to determine uplink subframe scheduling for a hybrid automatic repeat request procedure over a plurality of subframes; using the information to determine, for each transmission of the hybrid automatic repeat request procedure, whether to retransmit previously transmitted data or to transmit new data; and using the information to determine a modulation and coding scheme and a redundancy version for each transmission of the hybrid automatic repeat request procedure, in dependence on the determination of whether to retransmit previously transmitted data or to transmit new data; and the information received at the user equipment comprising information of at least one parameter which is common to each transmission of the hybrid automatic repeat request.

### FIELD

The present application relates to a method, apparatus, and computer program and in particular but not exclusively to transmission scheduling.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3rd Generation Partnership Project (3GPP). The various development stages of the 3GPP LTE specifications are referred to as releases. Certain releases of 3GPP LTE (e.g., LTE Rel-11, LTE Rel-12, LTE Rel-13) are targeted towards LTE-Advanced (LTE-A). LTE-A is directed towards extending and optimising the 3GPP LTE radio access technologies. Another proposed communication system is a 5G network.

### SUMMARY

In a first aspect there is provided a method comprising: receiving an uplink grant at a user equipment, the uplink grant comprising information; using the information to determine uplink subframe scheduling for a hybrid automatic repeat request procedure over a plurality of subframes; using the information to determine, for each transmission of the hybrid automatic repeat request procedure, whether to retransmit previously transmitted data or to transmit new data; and using the information to determine a modulation and coding scheme and a redundancy version for each transmission of the hybrid automatic repeat request procedure, in dependence on the determination of whether to retransmit previously transmitted data or to transmit new data; and the information received at the user equipment comprising information of at least one parameter which is common to each transmission of the hybrid automatic repeat request.

According to some embodiments the uplink grant further comprises information of uplink resource blocks allocated to the user equipment in the plurality of subframes.

According to some embodiments the parameter which is common to each transmission in the plurality of subframes comprises one or more of: the modulation and coding scheme; a transport block size index, a transport block size; the redundancy version; and information of a physical resource block allocation.

According to some embodiments the information comprises information for a plurality of scheduled subframes for the hybrid automatic repeat request procedure.

According to some embodiments the information for a plurality of scheduled subframes comprises one or more of: information of a first transmission subframe; information of a numerical quantity of transmission subframes.

According to some embodiments the method comprises using the information to determine a first uplink transmission subframe.

According to some embodiments the method comprises the user equipment implicitly determining the first uplink transmission subframe based on a time of receipt of the uplink grant.

According to some embodiments the method comprises using the information to determine a number of contiguous scheduled uplink subframes.

According to some embodiments, the method comprises determining whether transmission of a first uplink subframe needs to be delayed in accordance with a listen-before-talk procedure.

According to some embodiments, the information comprises a hybrid automatic repeat request process number associated with the first uplink transmission subframe, and the process number changes for each subsequent uplink transmission subframe.

According to some embodiments, changing the process number comprises cyclically increasing the process number.

According to some embodiments, when it is determined to transmit new data, the method further comprises deleting data from a transmission buffer of the user equipment.

According to some embodiments, when it is determined to transmit new data, a modulation and coding scheme is selected which is the same as a modulation and coding scheme indication provided in the uplink grant.

According to some embodiments, when it is determined to transmit new data, a value of the redundancy version is set to zero.

According to some embodiments, when it is determined to retransmit data, a modulation and coding scheme is selected in dependence on an indication of a value of the redundancy version.

According to some embodiments, when it is indicated that a transmission is a retransmission, whether to use a modulation and coding scheme and/or a transport block size from the current UL grant or from a previous UL grant is determined based upon a one-bit indication provided in the current UL grant.

According to some embodiments, the method is carried out in an unlicensed band.

According to a second aspect, there is provided a computer program product for a computer, comprising software code portions for performing the steps of the first aspect when said product is run on the computer.

According to a third aspect there is provided a method comprising: providing information comprising information for enabling a user equipment to determine uplink subframe scheduling for a hybrid automatic repeat request procedure over a plurality of subframes; the provided information comprising information of whether, for each transmission of the hybrid automatic repeat request procedure, the user equipment is to retransmit previously transmitted data or to transmit new data; and the provided information comprising information of a modulation and coding scheme and a redundancy version for each transmission of the hybrid automatic repeat request procedure, for use by the user equipment in dependence on whether to retransmit previously transmitted data or to transmit new data; and the provided information comprising information of at least one parameter which is common to each transmission of the hybrid automatic repeat request; and sending the information to a user equipment in an uplink grant.

According to some embodiments the uplink grant further comprises information of uplink resource blocks allocated to the user equipment.

According to some embodiments, the parameter which is common to each transmission in the plurality of subframes comprises one or more of: the modulation and coding scheme; a transport block size index; a transport block size; the redundancy version; and information of a physical resource block allocation.

According to some embodiments, the information comprises information for a plurality of scheduled subframes for the hybrid automatic repeat request procedure.

According to some embodiments the information for a plurality of scheduled subframes comprises one or more of: information of a first transmission subframe; information of a numerical quantity (e.g. a count) of transmission subframes.

According to some embodiments, the provided information comprises an indication of a first uplink transmission subframe.

According to some embodiments, the provided information comprises information of a number of contiguous scheduled uplink subframes.

According to some embodiments, the information comprises a hybrid automatic repeat request process number associated with the first uplink transmission subframe, and the process number changes for each subsequent uplink transmission subframe.

According to some embodiments, changing the process number comprises cyclically increasing the process number.

According to some embodiments, the method is carried out in an unlicensed band.

According to a fourth aspect, there is provided a computer program product for a computer, comprising software code portions for performing the steps of the second aspect when said product is run on the computer.

In a fifth aspect there is provided an apparatus comprising: at least one processor; and at least one memory including computer program code; the at least one memory and the computer program code configured to, with the at least one processor, cause the apparatus at least to: receive an uplink grant, the uplink grant comprising information; use the information to determine uplink subframe scheduling for a hybrid automatic repeat request procedure over a plurality of subframes; use the information to determine, for each transmission of the hybrid automatic repeat request procedure, whether to retransmit previously transmitted data or to transmit new data; and use the information to determine a modulation and coding scheme and a redundancy version for each transmission of the hybrid automatic repeat request procedure, in dependence on the determination of whether to retransmit previously transmitted data or to transmit new data; and the information received at the apparatus comprising information of at least one parameter which is common to each transmission of the hybrid automatic repeat request.

According to some embodiments the uplink grant further comprises information of uplink resource blocks allocated to the apparatus in the plurality of subframes.

According to some embodiments, the parameter which is common to each transmission in the plurality of subframes comprises one or more of: the modulation and coding scheme; a transport block size index, a transport block size; the redundancy version; and information of a physical resource block allocation.

According to some embodiments, the information comprises information for a plurality of scheduled subframes for the hybrid automatic repeat request procedure.

According to some embodiments the information for a plurality of scheduled subframes comprises one or more of: information of a first transmission subframe; information of a numerical quantity of transmission subframes.

According to some embodiments, the apparatus is configured to use the information to determine a first uplink transmission subframe.

According to some embodiments the apparatus implicitly determines the first uplink transmission subframe based on a time of receipt of the uplink grant.

According to some embodiments, the apparatus is configured to use the information to determine a number of contiguous scheduled uplink subframes.

According to some embodiments, the apparatus is configured to determine whether transmission of a first uplink subframe needs to be delayed in accordance with a listen-before-talk procedure.

According to some embodiments, the information comprises a hybrid automatic repeat request process number associated with the first uplink transmission subframe, and the process number changes for each subsequent uplink transmission subframe.

According to some embodiments, changing the process number comprises cyclically increasing the process number.

According to some embodiments, when it is determined to transmit new data, the apparatus is configured to delete data from a transmission buffer of the apparatus.

According to some embodiments, when it is determined to transmit new data, the apparatus is configured to select a modulation and coding scheme which is the same as a modulation and coding scheme indication provided in the uplink grant.

According to some embodiments, when it is determined to transmit new data, a value of the redundancy version is set to zero.

According to some embodiments, when it is determined to retransmit data, the apparatus is configured to select a modulation and coding scheme in dependence on an indication of a value of the redundancy version.

According to some embodiments, when it is indicated that a transmission is a retransmission, whether to use a modulation and coding scheme and/or a transport block size from the current UL grant or from a previous UL grant is determined based upon a one-bit indication provided in the current UL grant.

According to some embodiments, the apparatus is operating in an unlicensed band.

According to some embodiments, the apparatus comprises a user equipment.

In a sixth aspect there is provided an apparatus comprising: at least one processor; and at least one memory including computer program code; the at least one memory and the computer program code configured to, with the at least one processor, cause the apparatus at least to: provide information comprising information for enabling a user equipment to determine uplink subframe scheduling for a hybrid automatic repeat request procedure over a plurality of subframes; the provided information comprising information of whether, for each transmission of the hybrid automatic repeat request procedure, the user equipment is to retransmit previously transmitted data or to transmit new data; and the provided information comprising information of a modulation and coding scheme and a redundancy version for each transmission of the hybrid automatic repeat request procedure, for use by the user equipment in dependence on whether to retransmit previously transmitted data or to transmit new data; and the provided information comprising information of at least one parameter which is common to each transmission of the hybrid automatic repeat request; and send the information to a user equipment in an uplink grant.

According to some embodiments the uplink grant further comprises information of uplink resource blocks allocated to the user equipment.

According to some embodiments the parameter which is common to each transmission in the plurality of subframes comprises one or more of: the modulation and coding scheme; a transport block size index; a transport block size; the redundancy version; and information of a physical resource block allocation.

According to some embodiments the information comprises information for a plurality of scheduled subframes for the hybrid automatic repeat request procedure.

According to some embodiments the information for a plurality of scheduled subframes comprises one or more of: information of a first transmission subframe; information of a numerical quantity (e.g. a count) of transmission subframes.

According to some embodiments the provided information comprises an indication of a first uplink transmission subframe.

According to some embodiments, the provided information comprises information of a number of contiguous scheduled uplink subframes.

According to some embodiments the information comprises a hybrid automatic repeat request process number associated with the first uplink transmission subframe, and the process number changes for each subsequent uplink transmission subframe.

According to some embodiments, changing the process number comprises cyclically increasing the process number.

According to some embodiments, the apparatus is configured to operate in an unlicensed band.

According to some embodiments the apparatus comprises an eNodeB.

In a seventh aspect there is provided an apparatus comprising: means for receiving an uplink grant, the uplink grant comprising information; means for using the information to determine uplink subframe scheduling for a hybrid automatic repeat request procedure over a plurality of subframes; means for using the information to determine, for each transmission of the hybrid automatic repeat request procedure, whether to retransmit previously transmitted data or to transmit new data; and means for using the information to determine a modulation and coding scheme and a redundancy version for each transmission of the hybrid automatic repeat request procedure, in dependence on the determination of whether to retransmit previously transmitted data or to transmit new data; and the information received at the apparatus comprising information of at least one parameter which is common to each transmission of the hybrid automatic repeat request.

According to some embodiments the uplink grant further comprises information of uplink resource blocks allocated to the apparatus in the plurality of subframes.

According to some embodiments, the parameter which is common to each transmission in the plurality of subframes comprises one or more of: the modulation and coding scheme; a transport block size index, a transport block size; the redundancy version; and information of a physical resource block allocation.

According to some embodiments, the information comprises information for a plurality of scheduled subframes for the hybrid automatic repeat request procedure.

According to some embodiments the information for a plurality of scheduled subframes comprises one or more of: information of a first transmission subframe; information of a numerical quantity of transmission subframes.

According to some embodiments, the apparatus comprises means for using the information to determine a first uplink transmission subframe.

According to some embodiments the apparatus comprises means for implicitly determining the first uplink transmission subframe based on a time of receipt of the uplink grant.

According to some embodiments, the apparatus comprises means for using the information to determine a number of contiguous scheduled uplink subframes.

According to some embodiments, the apparatus comprises means for determining whether transmission of a first uplink subframe needs to be delayed in accordance with a listen-before-talk procedure.

According to some embodiments, the information comprises a hybrid automatic repeat request process number associated with the first uplink transmission subframe, and the process number changes for each subsequent uplink transmission subframe.

According to some embodiments, changing the process number comprises cyclically increasing the process number.

According to some embodiments, when it is determined to transmit new data, the apparatus comprises means for deleting data from a transmission buffer of the apparatus.

According to some embodiments, when it is determined to transmit new data, the apparatus comprises means for selecting a modulation and coding scheme which is the same as a modulation and coding scheme indication provided in the uplink grant.

According to some embodiments, when it is determined to transmit new data, a value of the redundancy version is set to zero.

According to some embodiments, when it is determined to retransmit data, the apparatus comprises means for selecting a modulation and coding scheme in dependence on an indication of a value of the redundancy version.

According to some embodiments, when it is indicated that a transmission is a retransmission, whether to use a modulation and coding scheme and/or a transport block size from the current UL grant or from a previous UL grant is determined based upon a one-bit indication provided in the current UL grant.

According to some embodiments, the apparatus comprises means for operating in an unlicensed band.

According to some embodiments, the apparatus comprises a user equipment.

In an eighth aspect there is provided an apparatus comprising: means for providing information comprising information for enabling a user equipment to determine uplink subframe scheduling for a hybrid automatic repeat request procedure over a plurality of subframes; the provided information comprising information of whether, for each transmission of the hybrid automatic repeat request procedure, the user equipment is to retransmit previously transmitted data or to transmit new data; and the provided information comprising information of a modulation and coding scheme and a redundancy version for each transmission of the hybrid automatic repeat request procedure, for use by the user equipment in dependence on whether to retransmit previously transmitted data or to transmit new data; and the provided information comprising information of at least one parameter which is common to each transmission of the hybrid automatic repeat request; and means for sending the information to a user equipment in an uplink grant.

According to some embodiments the uplink grant further comprises information of uplink resource blocks allocated to the user equipment.

According to some embodiments the parameter which is common to each transmission in the plurality of subframes comprises one or more of: the modulation and coding scheme; a transport block size index; a transport block size; the redundancy version; and information of a physical resource block allocation.

According to some embodiments the information comprises information for a plurality of scheduled subframes for the hybrid automatic repeat request procedure.

According to some embodiments the information for a plurality of scheduled subframes comprises one or more of: information of a first transmission subframe; information of a numerical quantity of transmission subframes.

According to some embodiments the provided information comprises an indication of a first uplink transmission subframe.

According to some embodiments, the provided information comprises information of a number of contiguous scheduled uplink subframes.

According to some embodiments the information comprises a hybrid automatic repeat request process number associated with the first uplink transmission subframe, and the process number changes for each subsequent uplink transmission subframe.

According to some embodiments, changing the process number comprises cyclically increasing the process number.

According to some embodiments, the apparatus comprises means for operating in an unlicensed band.

According to some embodiments the apparatus comprises an eNodeB.

### DESCRIPTION OF FIGURES

FIG. 1 shows a schematic diagram of an example communication system comprising a base station and a plurality of communication devices;

FIG. 2 shows a schematic diagram of an example mobile communication device;

FIG. 3 shows a schematic diagram of an example control apparatus;

FIG. 4 shows signalling between a UE and an eNodeB according to an embodiment;

FIG. 5 shows a resource allocation principle with Block-IFDMA;

FIG. 6 is a flow chart of a method according to an embodiment;

FIG. 7 is a flow chart of a method according to an embodiment.

### DETAILED DESCRIPTION

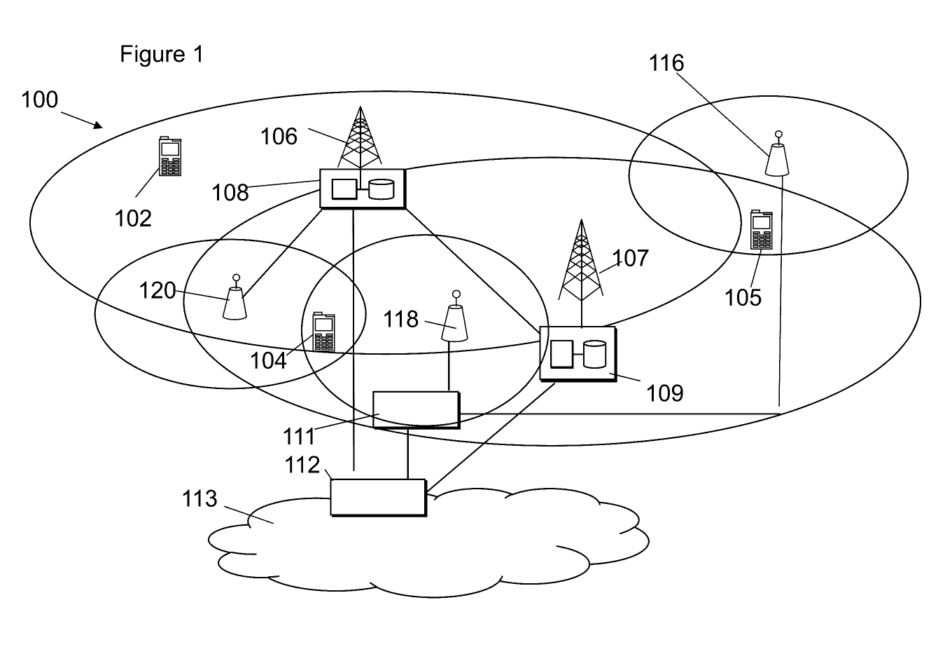

Before explaining in detail the examples, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

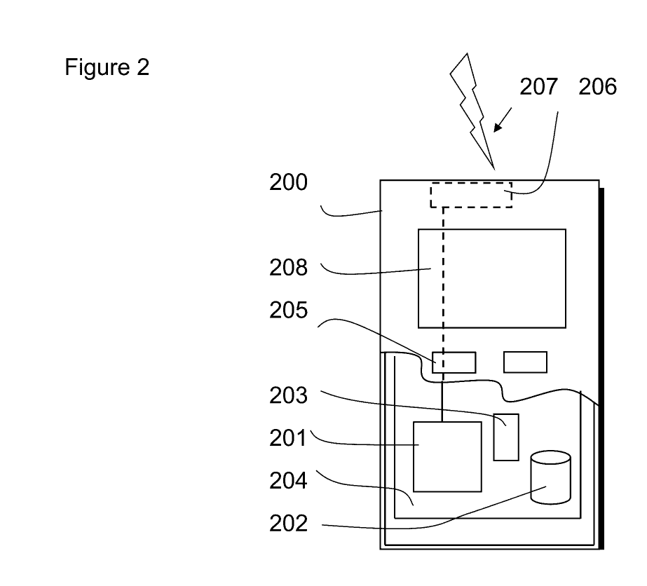

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access systems comprise those provided by base stations of systems that are based on technologies such as wireless local area network (WLAN) and/or WiMax (Worldwide Interoperability for Microwave Access). A base station can provide coverage for an entire cell or similar radio service area.

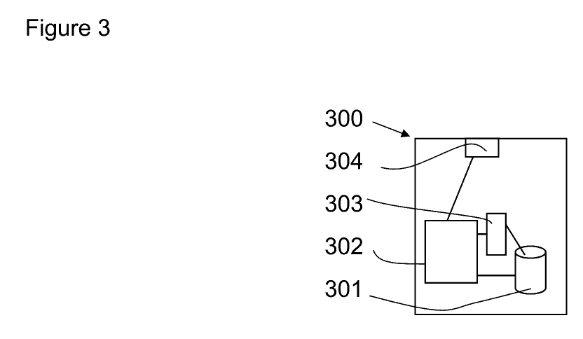

The methods described herein may be implemented on a mobile device as described with respect to FIG. 2 or a control apparatus as shown in FIG. 3. FIG. 3 shows an example of a control apparatus for a communication system, for example to be coupled to and/or for controlling a station of an access system, such as a RAN node, e.g. a base station, (e) node B or 5G AP, a central unit of a cloud architecture or a node of a core network such as an MME or S-GW, a scheduling entity, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 can be configured to execute an appropriate software code to provide the control functions. Control functions may comprise at least one of providing system information at a user device capable of operating using a discontinuous reception period, the system information comprising at least one system information block and an information element indicating one of a set of values and providing information to the user device, the information comprising an indication of wrap around of the set of values.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

Rel-13 LTE LAA (Licensed Assisted Access) provides licensed-assisted access to unlicensed spectrum while coexisting with other technologies and fulfilling the regulatory requirements. LTE in unlicensed spectrum (LTE-U) is a proposal for the use of LTE radio communications technology in the unlicensed spectrum, such as the 5 GHz band already populated by Wi-Fi devices. In Rel-13 LAA, unlicensed spectrum is utilized to improve LTE DL (downlink) throughput. One or more LAA DL SCell (secondary cell) may be configured to a UE as part of DL CA (carrier aggregation) configuration, while the PCell (primary cell) needs to be on the licensed spectrum. It is expected that Rel-13 LTE LAA will evolve to support also LAA UL transmissions on the unlicensed spectrum in LTE Rel-14.

LTE LAA operation (when UL operation is introduced in Rel-14) can apply the existing cross-carrier scheduling framework to schedule PUSCH (physical uplink shared channel) on the unlicensed band carrier with an UL grant transmitted over some licensed band carrier. However, it has been proposed to extend LAA with dual connectivity operation (i.e. allowing for non-ideal backhaul between PCell in licensed spectrum and SCell(s) in unlicensed spectrum), and even in standalone LTE operation on unlicensed spectrum. LTE standalone operation on unlicensed spectrum would mean that the eNB/UE air interface relies solely on unlicensed spectrum without any carrier on the licensed spectrum.

Cross-Carrier scheduling for PUSCH on the unlicensed band carrier from a licensed band carrier is not possible in the dual connectivity/standalone scenarios. Hence, self-scheduling for PUSCH needs to be defined at least for those scenarios. In addition to that, efficient self-scheduling for PUSCH would be beneficial for LTE LAA operation since it allows for offloading the DCI (downlink control information) carrying the UL grant from the scheduling cell on licensed spectrum to the SCell(s) operating on unlicensed spectrum. The foregoing considers self-scheduling arrangement for PUSCH, which can be applied in both LAA and dual connectivity/standalone scenarios on unlicensed band.

In LTE operation on unlicensed carriers, depending on the regulatory rules, the UE may need to perform Listen-Before-Talk (LBT) prior to UL (uplink) transmissions. This may add complexity to UL data scheduling, especially in the case of self-scheduling where both scheduling node (i.e. eNB) and transmitting node (i.e. UE) may need to perform LBT.

In the present (i.e. licensed band) LTE systems, UL user multiplexing relies on both FDM (frequency-division multiplexing) within a subframe as well as TDM (time-division multiplexing) between subframes. The requirement to perform LBT before the start of each transmission would in the case of TDM mean that a short gap in time allowing for UEs to perform LBT needs to be reserved between the UL subframes where different UEs might be scheduled. This may result in unnecessary overhead and also allow for other contending nodes (such as WiFi) to occupy the channel. Therefore TDM within an UL transmission burst (UL TXOP (uplink transmission opportunity)) may not be a preferred way of multiplexing UEs in UL in unlicensed LTE operation. Instead, one could primarily rely on FDM, i.e. allocation of different frequency resources (e.g. PRBs) for different users, and correspondingly allocate the same frequency resources for a given user in all the UL subframes of the TXOP.

In principle, the network can allocate the same UL resources for a UE in multiple consecutive subframes through using the currently available LTE Downlink Control Information (DCI), namely UL grants, to be transmitted in several consecutive DL subframes. A drawback of this approach is that the eNodeB transmits a lot of redundant information in several subframes, as most of the content would be the same in each of the individual UL grants containing the scheduling information of a single subframe. In order to reduce the related DCI signaling overhead in a scenario like this, Multi-Subframe Scheduling has been proposed (see e.g. 3GPP contribution R1-151082, “Control signaling and HARQ operation in LAA”, LG Electronics, 3GPP RAN1 LAA Ad-Hoc, March 2015).

One potential scenario is a UL-heavy traffic case, where a large number of consecutive subframes may be used to serve uplink traffic of UEs connected to the network, and the downlink transmissions are intentionally minimized to enable more time for UL operation. In a typical scenario for UL heavy operation, e.g. file upload, the network will want to allocate UL heavy configuration (i.e. large number of consecutive UL subframes in comparison to the number of DL subframes) for multiple consecutive TXOPs. Here, the handling of UL grant transmission in general and specifically the combination of handling initial and retransmissions may become problematic as there is only a reduced number of DL subframes available for sending UL grants. In principle it would be possible to have multiple UL grants transmitted simultaneously in a single subframe, but that may lead to unpredictable error cases, for example.

LTE Frame Structure 2 (TDD) supports as a special case resource allocation of two UL subframes with one UL grant. The usage of multi-subframe scheduling in TD-LTE is though limited to TDD UL/DL configuration #0 (“UL-heavy”). Furthermore, multi-subframe scheduling was one of the potential small cell enhancements considered during Rel-12 study item phase. However, discussions of small cell enhancements have not gone any further than discussing related limitations and general operation, and have not discussed specific DCI mechanisms.

Furthermore, Rel-12 discussions focused solely on the licensed band scenario without any consideration on the unlicensed band operation. For example, and as identified in the present application, LBT applied in unlicensed band may stabilize the interference between subframes (especially in UL) since LBT may block interfering nodes during the UL Tx burst. In the legacy scenario, scheduled UEs vary from subframe-to-subframe and from PRB-to-PRB, which may create an interference scenario varying heavily in time and frequency. Another difference compared to Rel-12 scenario is that based on current decisions available, the methods discussed herein are operable with asynchronous HARQ operation whereas legacy UL in operation in LTE is presently based on synchronous HARQ. This means for example that there is no need for PHICH in the unlicensed band operation.

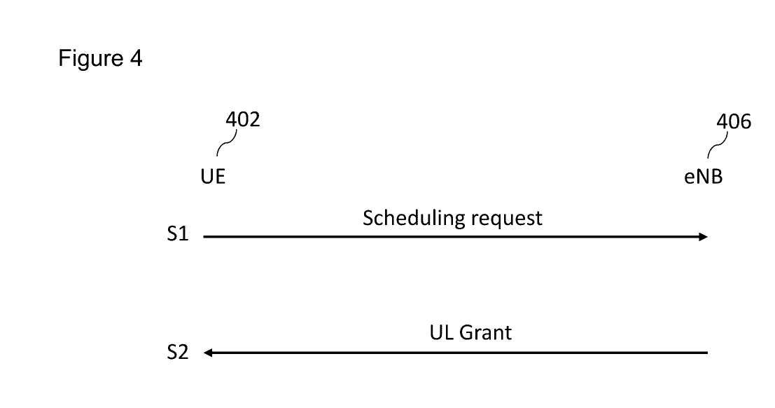

When a user equipment needs to transmit information it may send a scheduling request (SR) to a logical node, such as an eNodeB. This is shown for example in FIG. 4. At step S1 the UE 402 sends a scheduling request to the eNB 406. In response to this, at step S2 the eNB 406 sends to the UE an uplink (UL) grant. The UL grant includes information that enables the UE 402 to make decisions regarding transmission parameters, for example when to begin transmitting. It will also be understood that SR initiated UL grant is just one example. For example PRACH may also be used for triggering the UL grant.

The received UL grant (i.e. UL grant received at the UE at step S2) may be considered a “current” UL grant. UL grant(s) received earlier may be considered previous UL grant(s), and UL grant(s) received later may be considered subsequent UL grant(s).

According to the present application a UL grant format is proposed which is capable of scheduling multiple subframes. For example the UL grant provides scheduling information for a first transmission. The uplink grant also contains information for further transmission(s). The further transmission(s) may comprise retransmission(s). The proposed UL grant format may therefore be considered as a form of “super” grant. The information to be contained in the UL grant, as described further below, may be considered as a set of rules for UL grant content.

The proposed “super” UL grant may be capable of addressing full flexibility of scheduling initial and retransmissions in consecutive subframes with a single UL grant/DCI. The proposed UL grant may enable scheduling of all HARQ processes with the UL grant, including retransmissions, while keeping the UL grant size as compact as possible.

Information contained in the UL grant may include: subframe (SF) allocation; resource block (RB) allocation; HARQ process; New Data Indicator (NDI); Modulation and Coding Scheme (MCS); Redundancy Version (RV). These fields may be included in the UL grant in the form of information elements (IEs). These are discussed in more detail below.

Subframe Allocation

The UL grant includes a subframe allocation. This can be used by the UE to determine in which subframes it may transmit. The subframe allocation may comprise contiguous subframes. The subframe allocation may comprise non-contiguous subframes. In some embodiments the subframe allocation may comprise a mixture of contiguous and non-contiguous subframes.

The UL grant may indicate a first scheduled UL subframe m. That is the UL grant may indicate to the UE an identity of the first subframe in which the UE is allowed to transmit.

Alternatively, the first subframe m may be implicitly determined by the UE. For example the UE can implicitly determine the first subframe m based on a time at which the UL grant was received. For example the first subframe m may be determined to be a certain number of subframes (for example 4 subframes) after the subframe in which the corresponding UL grant is received. For example, as per LTE (FDD) where a UL grant received in subframe n triggers UL PUSCH transmission in subframe n+4.

In some embodiments the UL grant may specify or indicate a number of contiguous scheduled UL subframes. For example the number of contiguous UL subframes may be N.

A maximum number of contiguous subframes Nmax (or N_max) may be specified. The Nmax may be either fixed in the specifications or configured semi-statically via higher layer signalling. In some embodiments Nmax may be included in the UL grant. Nmax is the maximum number of scheduled subframes available to the UE for transmitting in a given allocation.

It will therefore be understood that in this context the term “number” is used to denote a numerical quantity.

According to some embodiments the UL grant may indicate or specify whether UL subframes are subject to a Listen Before Talk (LBT) procedure. This indication may comprise 1-bit of the UL grant. LBT is a contention-based protocol used in wireless communications by allowing several users to share the same spectrum or channel. If one user wants to transmit information, that user will have to check that the channel is currently not in use before transmitting. UL LBT—related parameters can also be included in the UL grant. For example, there can be a random backoff counter and/or starting time of the LBT operation included in the UL grant.

If the channel is not being used then the UE can transmit the information. In embodiments, if the channel is clear (i.e. unoccupied before the start of the UL transmission), the UE can transmit in multiple UL subframes in accordance with the UL grant.

If, on the other hand, the channel is observed to be occupied before the start of the UL transmission then the UE can continue with the LBT procedure and transmit subsequent UL subframes at a time when the channel becomes vacant. In embodiments the UE will determine (for example by measurements) whether the channel is occupied or not. Alternatively, the UE can omit transmission of all the UL subframes scheduled with the UL grant and start monitoring the physical downlink control channel (PDCCH). Therefore if LBT prevents UL transmissions, it may still be possible for the eNodeB to transmit in the DL.

Physical Resource Block (PRB) Allocation

A PRB is a time and frequency resource that typically occupies 12 subcarriers and one slot (0.5 ms). In LTE, PRBs are typically allocated in pairs extending over one subframe (1 ms) by the scheduler. In at least some embodiments according to the present application multiple consecutive PRBs can be allocated in time. The PRB allocation specifies or indicates to the UE which PRB or PRBs to use when transmitting according to the schedule defined in the UL grant. In some embodiments this field is common for all the scheduled UL subframes. That is in some embodiments the UL grant will assign to a UE the same frequency resources, for all of the scheduled UL subframes. In some embodiments the PRB allocation will occupy 5 to 10 bits of the UL grant. For example resource allocation based on Block-IFDMA (interleaved frequency division multiple access) utilizes ten interlaces of one or more physical resource blocks (PRBs), each of which can be supported with 6 bits.

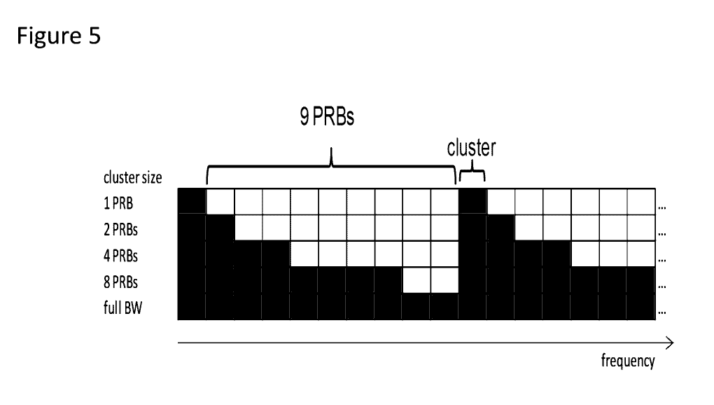

An example of PRB allocation is shown in FIG. 5. A basic allocation unit comprises block-IFDMA with 10 equally spaced clusters of 20 MHz bandwidth. A variable PUSCH bandwidth is obtained by variable cluster sizes. A minimum cluster size is 1 PRB. Supported cluster sizes include [1, 2, 3, 4, 5, 6, (7), 8, 9, 10]. A cluster size of 10 is considered a full bandwidth. A cluster size of 7 PRBs may or may not be supported. Cluster size of 7 PRBs results in allocation of 70 PRBs in total, which is not divisible by small prime numbers 2, 3, or 5 and hence may result in more complex Discrete Fourier Transform (DFT) design at the receiver and the transmitter than in current LTE releases. Therefore not using a cluster size of 7 may reduce complexity.

Each signalling state may indicate one combination of cluster size and the starting PRB. This means that the total number of signalling states needed on 20 MHz bandwidth is:
10 (1 PRBs)+9+8+7+7+5+4+3+2 (9 PRBs)+1 (full BW)=55 states

This can be carried out by 6-bit signalling supporting up-to 64 signalling states.

Initiating HARQ (Hybrid Automatic Repeat Request) Process

According to some embodiments the eNodeB indicates to the UE with the UL grant a HARQ process number associated with the first scheduled UL subframe m. In LTE there are for example in FDD 8 parallel HARQ processes. For each HARQ process the eNodeB may request the UE to transmit either new data (first transmission) or to retransmit the same data again, if the data was not received correctly the previous time. Further, a single PUSCH transmission in a subframe may correspond to 1 HARQ process. Therefore there can be 8 parallel transmissions (each being within a subframe) pending, from HARQ point of view. LTE applies so called stop-and-wait HARQ protocol which is based on parallel HARQ processes. The process number may therefore be considered as an index of the HARQ process. The process number may comprise an index of the HARQ process of the first scheduled UL subframe. This can be denoted, for example, as HARQ_process_number(m).

According to some embodiments the HARQ process number for subsequent UL subframes can be defined as:
modulo(HARQ_process_number(m)+SF_index_rel, total number of HARQ processes);
where:
HARQ_process_number(m) is the HARQ process number of the first scheduled UL subframe in the UL TXOP, i.e. UL subframe m with SF_index_rel=0, and:
SF_index_rel (0, . . . , N−1) is the relative index of the UL subframe with respect to subframe m.

For example, for the first scheduled subframe m the SF_index_rel=0, for the second scheduled subframe m+1 the SF_index_rel=1, and so on.

It is expected that according to some embodiments the portion of the UL grant initiating the HARQ process will occupy 3 to 4 bits.

New Data Indicator (NDI)

According to some embodiments the UL grant comprises information which indicates for each HARQ process whether the UE should retransmit the data in the HARQ buffer (e.g. data already transmitted or attempted to be transmitted as part of the HARQ process), or transmit new data. The HARQ buffer may also be cleared as part of a process of transmitting new data. This portion of the UL grant may be referred to as a new data indicator (NDI).

According to some embodiments the NDI comprises a bitmap. The size of the bitmap may be dependent on the number of HARQ processes and/or the maximum number of schedulable subframes (Nmax). In some embodiments the bitmap comprises 10 bits. As discussed above a maximum number of contiguous subframes Nmax may be specified. The Nmax may be either fixed in the specifications or configured semi-statically via higher layer signalling.

In some embodiments, where the network indicates to the UE the parameter Nmax, the length of the bitmap can be set equal to it. For example if the parameter Nmax specifies 10 subframes, then the length of the bitmap can be set to 10 frames. Otherwise, the length of the bitmap can be provided by the specification.

According to at least some embodiments there is a relationship between the number of HARQ processes and N_max. As the number of pending processes is limited by the number of HARQ processes, it will not be possible to have a longer continuous transmission than given by the maximum number of supported HARQ processes. Therefore, in at least some embodiments N_max is smaller than the number of HARQ processes. The number of HARQ processes is typically given in the specifications, but N_max might be configurable.

According to some embodiments there is one bit corresponding to each HARQ process. Therefore if there are 8 HARQ processes, then the bitmap will be 8 bits. If N_max is smaller than the number of HARQ processes then the length of the bitmap would be equal to N_max. In other embodiments, the HARQ processes will be represented by a modified version of a bitmap. For instance in case the DCI format size needs reduction, a compressed version of the bitmap could be achieved through compression or clustering of processes at the expense of HARQ process signalling flexibility.

In some embodiments, where uplink single user multiple-input multiple-output (UL SU-MIMO) is supported, the NDI of the two transport blocks can be bundled together. The NDI may indicate new data by changing its state compared to a previous NDI. With a bundled NDI, the NDI values will not diverge. Alternatively, in the case of SU-MIMO there may be a dedicated NDI for each transport block in each subframe, leading to a doubling of the number of NDI bits required.

It will be understood that the eNB can generate the NDI information, or can forward the information from higher layers to the UE.

In cases where Nmax is not configured by the network (either the eNB or higher layers) to the UE, the size of the grant and the number of contained NDI bits may vary. Therefore the UE might look for a different grant size and needs to interpret the bits contained in the grant differently, due to the different size. In this case, it's also possible that the UE derives at least one size option for UL grant from separate signalling by the eNB indicating the length of UL TX burst/TxOP. In embodiments the UE is monitoring multiple different sizes of grants, but only one grant will be transmitted by the eNodeB.

MCS and RV

According to some embodiments, there is a common modulation and coding scheme (MCS) for the first/initial transmissions. Also, for the first/initial transmissions the redundancy version (RV) can be set to zero. The RV sets out which “version” or round of a HARQ transmission is being referred to. For example four RVs [0, 1, 2, 3] can be used. In some implementations the RVs are repeatedly sequenced through until the packet is received correctly or until a maximum number of retransmissions have been sent. If the packet has not been successfully received after the maximum number of retransmissions then HARQ declares a failure and leaves it up to ARQ running in radio link control (RLC) to try again. For LTE DL, the RV is not fixed but given by the DL grant, and therefore there is no sequencing through it. For UL on a licensed band there is a certain relationship of the RV used—namely [0, 2, 1, 3] for the 1st, 2nd, 3rd and 4th transmissions respectively. For unlicensed band DL there may be no cycling, and the indication may be provided in the UL grant similarly as in the DL grant on LTE licensed carriers.

For the retransmissions (i.e. for each HARQ process for which a retransmission is indicated with the individual NDI(s)), an additional common (i.e. applied for all retransmissions) 2-bit RV indicator may be provided which indicates the redundancy version [0, 1, 2, 3]. A one-bit retransmission MCS indicator may also be provided.

According to some embodiments, in the case of a 2-bit RV indication and no additional retransmission MCS indication:
if RV=1, 2, or 3 is indicated, the UE shall use the same MCS and/or TBS (transport block size) as in the initial (i.e. first) transmission, i.e. the MCS and/or TBS indicated in the previous UL grant
If RV=0 is indicated, the UE shall use the same MCS and/or TBS as indicated in the same or “current” UL grant.

In some embodiments the UE grant will have only one MCS/TBS field. It may be preferred that for retransmissions the MCS and/or TBS is chosen to be the same as in the first transmission, if for example the resource allocation has changed from the previous transmission.

In other embodiments, alternative formulations can be provided. In one potential alternative, the following is proposed:
If RV=0, 2, or 3 is indicated, the UE shall use the same MCS and/or TBS as in the initial (i.e. first) transmission, i.e. the MCS/TBS indicated in the previous UL grant.
If RV=1 is indicated, the UE shall use the same MCS and/or TBS as indicated in the same or “current” UL grant

This allows for the utilisation of Chase Combining (CC) with the same MCS as in the initial transmission.

In a case with a one-bit retransmission MCS indicator, the retransmission MCS indicator may explicitly inform the UE whether the MCS and/or TBS should be the same as in the initial transmission, or if it should be the same as in the current grant, regardless of the RV that is indicated with the two other bits giving directly the RV [0 . . . 3].

According to some embodiments, 7 to 8 bits of the UL grant will be occupied by information pertaining to MCS and RV.

It will be understood that the information contained in the UL grant may be determined by the eNB. Alternatively the information in the UL grant may have been determined by higher layers and is passed on to the UE via the eNB. The content of the UL grant may also comprise a combination of information that has been determined by the eNB and information that has been determined by higher layers.

It will also be understood that the UL grant is not limited to contain the IEs discussed in detail above. The UL grant may include further IEs such as channel sounding, CSI measurement and reporting etc.

According to embodiments at least one parameter is common to each subframe of the HARQ procedure. The UL grant may indicate which parameter is to be common to each subframe. For example the parameter to remain constant may comprise one or more of: the modulation and coding scheme; a transport block size index, a transport block size, the redundancy version; and information of a physical resource block allocation.

It will be understood that the term “determining” encompasses varying levels of processing by an entity. Determining may involve an entity processing one or more values or parameters to generate an output, such as a decision. For example a UE may determine a first uplink transmission subframe based on various received parameters. Determining may also comprise simply receiving and acting on a received instruction. For example a UE may determine a first uplink transmission subframe based upon a received instruction from an eNodeB to first transmit in a particular subframe.

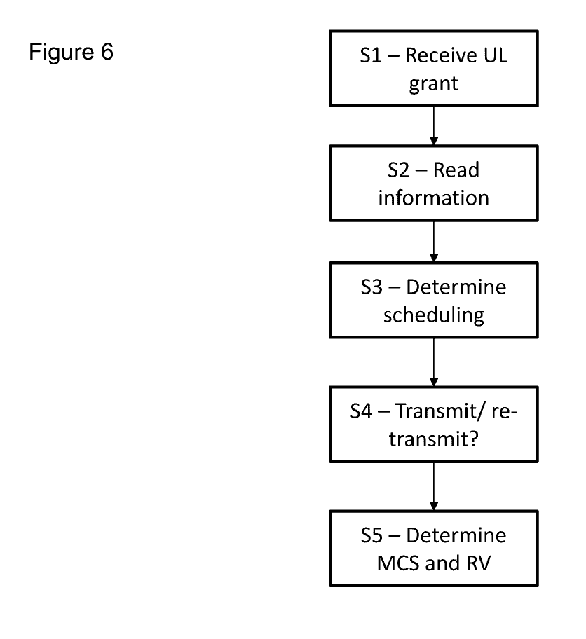

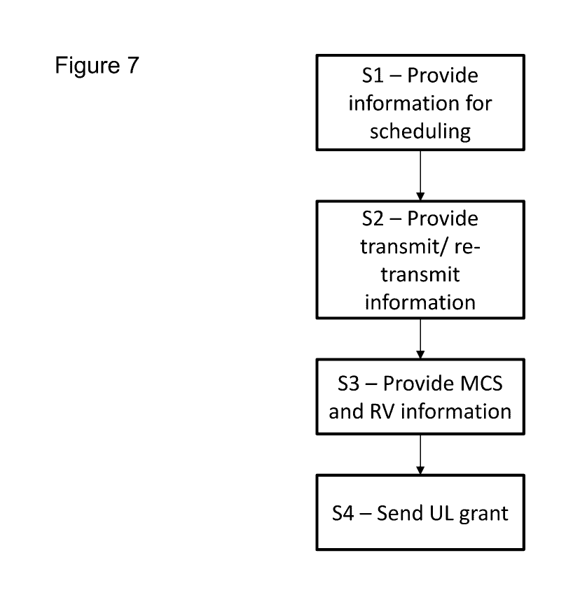

Methods according to some embodiments will now be described with respect to the flow charts of FIGS. 6 and 7.

FIG. 6 is viewed from the perspective of a user equipment.

At step S1 the UE receives a UL grant. The UL grant may be received from an eNB.

At step S2, the UE reads information contained in the UL grant. The information may be in the form of one or more IEs (information elements).

At step S3, the UE uses the information to determine uplink subframe scheduling for a hybrid automatic repeat request procedure over a plurality of subframes.

At step S4, the UE uses the information to determine, for each transmission of the hybrid automatic repeat request procedure, whether to retransmit previously transmitted data or to transmit new data.

At step S5, the UE uses the information to determine a modulation and coding scheme and a redundancy version for each transmission of the hybrid automatic repeat request procedure, in dependence on the determination of whether to retransmit previously transmitted data or to transmit new data. This step may optionally comprise operating in accordance with an LBT procedure.

It will be understood that FIG. 6 is a non-limiting example, and at least some of the steps can be performed in a different order to that set-out in FIG. 6.

In embodiments the information received at the user equipment comprises information of at least one parameter which is common to each transmission of the hybrid automatic repeat request.

FIG. 7 is viewed from the perspective of an eNB.

At step S1 the eNB provides information comprising information for enabling a user equipment to determine uplink subframe scheduling for a hybrid automatic repeat request procedure over a plurality of subframes.

At step S2 the eNB provides information comprising information of whether, for each transmission of the hybrid automatic repeat request procedure, the user equipment is to retransmit previously transmitted data or to transmit new data.

At step S3 the eNB provides information of a modulation and coding scheme and a redundancy version for each transmission of the hybrid automatic repeat request procedure, for use by the user equipment in dependence on whether to retransmit previously transmitted data or to transmit new data.

At step S4 the eNB sends the provided information to a UE in an uplink grant. Optionally, the method may also comprise a step of receiving information causing the eNodeB to send an uplink grant. For example the received information may be a scheduling request received from a UE.

It will be understood that FIG. 7 is a non-limiting example, and at least some of the steps can be performed in a different order to that shown in FIG. 7.

In embodiments the information provided to the user equipment comprises information of at least one parameter which is common to each transmission of the hybrid automatic repeat request.

Thus, according to the present application methods, apparatus and computer programs are disclosed which provide features for a UL grant for operating UL scheduling with multi-subframe grant. The scheduling can be applicable to HARQ processes/retransmission management. This may be of benefit in UL heavy UL-DL structures. The described methods and apparatus may also be deployed in unlicensed access areas.

As described further below the size of the proposed “super” UL grant is only moderately larger than the current single-subframe UL Grant (DCI format 0).

Table 1 below lists the bit widths of some information elements (IEs) in the new UL grant described herein, in comparison with the current UL grant i.e. DCI format 0.

TABLE 1

| | | Number of bits |
|---|---|---|
| | Number of bits for | for LTE reference |
| Information Element | “Super” UL grant | (DCI format 0) |
| Subframe allocation | 3-5* | 0 |
| Resource block allocation | 6** | 14 |
| Starting HARQ process | 4* | 0 |
| NDI (assuming e.g. Nₘₐₓ = | 10* | 1 |
| 10) | | |
| MCS + RV | 7-8* | 5 |
| Cyclic shift for DM RS and | 3 | 3 |
| OCC index | | |
| Aperiodic CSI trigger | 1-3 depending | 1-3 depending |
| | on the CA scenario | on the CA scenario |
| Frequency hopping flag | 0** | 1 |
| Carrier Indicator Field | 0 or 3 | 0 or 3 |
| PUSCH power control | 2 | 2 |
| command | | |
| SRS trigger | 0-1 | 0-1 |
| CRC | 16 | 16 |
| Total | 53-59 | 43-49 |

IEs requiring additional bits compared to the current DCI are denoted with a *.
IEs requiring fewer bits compared to the current DCI are denoted with a **.
As can be seen the proposed UL grant requires a relatively small increase of about ten bits compared to a normal single-subframe UL grant. Therefore, compared with the multiple single-subframe UL grants that would be required for scheduling multiple subframes, the proposed UL grant can result in a significant saving in the total number of bits required.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The above described operations may require data processing in the various entities. The data processing may be provided by means of one or more data processors. Similarly various entities described in the above embodiments may be implemented within a single or a plurality of data processing entities and/or data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a server.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

It is also noted herein that while the above describes exemplifying embodiments of the invention, there are several variations and modifications which may be made to the disclosed solution without departing from the scope of the present invention.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method comprising:
receiving an uplink grant at a user equipment, the uplink grant comprising information;
using the information to determine uplink subframe scheduling for a hybrid automatic repeat request procedure over a plurality of subframes;
using the information to determine, for each transmission of the hybrid automatic repeat request procedure, whether to retransmit previously transmitted data or to transmit new data; and
using the information to determine a modulation and coding scheme and a redundancy version for each transmission of the hybrid automatic repeat request procedure, in dependence on the determination of whether to retransmit previously transmitted data or to transmit new data; and
the information received at the user equipment comprising information of at least one parameter which is common to each transmission of the hybrid automatic repeat request.

2. A method according to claim 1, wherein the parameter which is common to each transmission in the plurality of subframes comprises one or more of: the modulation and coding scheme; a transport block size index, a transport block size; the redundancy version; and information of a physical resource block allocation.

3. A method according to claim 1, wherein the information comprises information for a plurality of scheduled subframes for the hybrid automatic repeat request procedure.

4. A method according to claim 1, comprising using the information to determine a first uplink transmission subframe.

5. A method according to claim 1, comprising using the information to determine a number of contiguous scheduled uplink subframes.

6. A method according to claim 1, wherein the information comprises a hybrid automatic repeat request process number associated with the first uplink transmission subframe, and the process number changes for each subsequent uplink transmission subframe.

7. A method according to claim 1, wherein when it is determined to transmit new data, a modulation and coding scheme is selected which is the same as a modulation and coding scheme indication provided in the uplink grant.

8. A method according to claim 1, wherein when it is determined to retransmit data, a modulation and coding scheme is selected in dependence on an indication of a value of the redundancy version.

9. A method comprising:
providing information comprising information for enabling a user equipment to determine uplink subframe scheduling for a hybrid automatic repeat request procedure over a plurality of subframes;
the provided information comprising information of whether, for each transmission of the hybrid automatic repeat request procedure, the user equipment is to retransmit previously transmitted data or to transmit new data; and
the provided information comprising information of a modulation and coding scheme and a redundancy version for each transmission of the hybrid automatic repeat request procedure, for use by the user equipment in dependence on whether to retransmit previously transmitted data or to transmit new data; and
the provided information comprising information of at least one parameter which is common to each transmission of the hybrid automatic repeat request; and
sending the information to a user equipment in an uplink grant.

10. A method according to claim 9, wherein the parameter which is common to each transmission in the plurality of subframes comprises one or more of: the modulation and coding scheme; a transport block size index; a transport block size; the redundancy version; and information of a physical resource block allocation.

11. A method according to claim 9, wherein the information comprises information for a plurality of scheduled subframes for the hybrid automatic repeat request procedure.

12. A method according to claim 9, wherein the provided information comprises an indication of a first uplink transmission subframe.

13. A method according to claim 9, wherein the information comprises a hybrid automatic repeat request process number associated with the first uplink transmission subframe, and the process number changes for each subsequent uplink transmission subframe.

14. A computer program product for a computer, comprising software code portions for performing the method of claim 1 when said product is run on the computer.

15. An apparatus comprising:
at least one processor;
and at least one memory including computer program code;
the at least one memory and the computer program code configured to, with the at least one processor, cause the apparatus at least to:
receive an uplink grant, the uplink grant comprising information;
use the information to determine uplink subframe scheduling for a hybrid automatic repeat request procedure over a plurality of subframes;
use the information to determine, for each transmission of the hybrid automatic repeat request procedure, whether to retransmit previously transmitted data or to transmit new data; and
use the information to determine a modulation and coding scheme and a redundancy version for each transmission of the hybrid automatic repeat request procedure, in dependence on the determination of whether to retransmit previously transmitted data or to transmit new data; and
the information received at the apparatus comprising information of at least one parameter which is common to each transmission of the hybrid automatic repeat request.

16. An apparatus according to claim 15, wherein the parameter which is common to each transmission in the plurality of subframes comprises one or more of: the modulation and coding scheme; a transport block size index, a transport block size; the redundancy version; and information of a physical resource block allocation.

17. An apparatus according to claim 15, wherein the information comprises information for a plurality of scheduled subframes for the hybrid automatic repeat request procedure.

18. An apparatus according to claim 15, wherein the apparatus is configured to use the information to determine a first uplink transmission subframe.

19. An apparatus according to claim 15, wherein the apparatus is configured to use the information to determine a number of contiguous scheduled uplink subframes.

20. An apparatus according to claim 15, wherein the information comprises a hybrid automatic repeat request process number associated with the first uplink transmission subframe, and the process number changes for each subsequent uplink transmission subframe.

21. An apparatus according to claim 15, wherein when it is determined to transmit new data, the apparatus is configured to select a modulation and coding scheme which is the same as a modulation and coding scheme indication provided in the uplink grant.

22. An apparatus comprising
at least one processor;
and at least one memory including computer program code;
the at least one memory and the computer program code configured to, with the at least one processor, cause the apparatus at least to:
provide information comprising information for enabling a user equipment to determine uplink subframe scheduling for a hybrid automatic repeat request procedure over a plurality of subframes;
the provided information comprising information of whether, for each transmission of the hybrid automatic repeat request procedure, the user equipment is to retransmit previously transmitted data or to transmit new data; and
the provided information comprising information of a modulation and coding scheme and a redundancy version for each transmission of the hybrid automatic repeat request procedure, for use by the user equipment in dependence on whether to retransmit previously transmitted data or to transmit new data; and
the provided information comprising information of at least one parameter which is common to each transmission of the hybrid automatic repeat request; and
send the information to a user equipment in an uplink grant.

23. An apparatus according to claim 22, wherein the parameter which is common to each transmission in the plurality of subframes comprises one or more of: the modulation and coding scheme; a transport block size index; a transport block size; the redundancy version; and information of a physical resource block allocation.

24. An apparatus according to claim 22, wherein the information comprises information for a plurality of scheduled subframes for the hybrid automatic repeat request procedure.

25. An apparatus according to claim 22, wherein the provided information comprises an indication of a first uplink transmission subframe.

26. An apparatus according to claim 22, wherein the information comprises a hybrid automatic repeat request process number associated with the first uplink transmission subframe, and the process number changes for each subsequent uplink transmission subframe.
